(19) United States
(12) Patent Application Publication
(10) Pub. No.: US 2023/0339722 A1
(43) Pub. Date: Oct. 26, 2023

(54) CONTROL OF OPERATION OF A CONVEYOR SYSTEM

(71) Applicant: KONE Corporation, Helsinki (FI)

(72) Inventor: Lauri STOLT, Helsinki (FI)

(73) Assignee: KONE Corporation, Helsinki (FI)

(21) Appl. No.: 18/216,929

(22) Filed: Jun. 30, 2023

Related U.S. Application Data
(63) Continuation of application No. PCT/FI2021/050011, filed on Jan. 8, 2021.

(51) Int. Cl. B66B 1/34

(52) U.S. Cl. CPC B66B 1/3415

(57) ABSTRACT

The invention relates to a method for monitoring an activity of a user controlling an operation of a conveyor system with a remote control device, the method comprises: receiving control data from the remote control device, the control data defining user input provided at least in accordance with time; comparing the control data to a reference data; and setting, in accordance with a comparison between the control data and the reference data, a detection result to express one of the following: (i) a continuation of the operation of the conveyor system, (ii) a discontinuation of the operation of the conveyor system. The invention also relates to a control device, to a system, and to a computer program product.

### TECHNICAL FIELD

The invention concerns in general the technical field of conveyor systems. More particularly, the invention concerns a control of an operation of the conveyor system.

### BACKGROUND

A movement of an elevator car within an elevator shaft is controlled by generating control signals to an elevator drive, or to any similar power generation means, such as to linear motors in so-called ropeless elevator systems. This causes the elevator car to move within the shaft in a predefined speed and, respectively, by controlling the power generating means it possible to decelerate the elevator car, or even to stop it e.g. at a landing. In other words, in the normal use such control signals may be generated in response to a receipt of a service call and/or based on sensor information obtained from the elevator system.

However, there are special situations in which there is a need to allow a person to control the movement of the elevator car manually. Such situations may e.g. relate to maintenance work of the elevator system and/or to emergency situations. For such situations there are developed solutions in which an elevator car is equipped with buttons whose activation may generate a control signal for upward or downward movement of the elevator car to the power generation means. Such buttons, like spring loaded buttons, may e.g. reside in a maintenance space of the elevator system, or on a roof of the elevator car. Due to safety requirements the buttons are implemented with the spring loaded structure so as to cause a stop of the movement if the button is released. Usually, there is also arranged a specific button to cause the stopping e.g. for situation that the upward or the downward button gets stuck when activated. Such a button may be considered as a so-called emergency stop button.

The development of the elevator systems has introduced new interfaces for connecting to the elevator systems. At least some of such interfaces are introduced for allowing so-called remote control devices e.g. carried by a technician of the elevator system to connect to the elevator system. The interfaces may allow a wireless or a wired connection of the remote control device to the elevator system so as to enable a control of a number of functionalities of the elevator system, such as controlling a movement of the elevator car with the remote control device.

Due to safety reasons, e.g. defined in safety standards of the elevator systems, there is need to introduce solutions which enable a quick control of the elevator system with the remote control device.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control device, a system, and a computer program product for monitoring an activity of a user controlling an operation of a conveyor system.

The objects of the invention are reached by a method, a control device, a system, and a computer program product as defined by the respective independent claims.

According to a first aspect, a method for monitoring an activity of a user controlling an operation of a conveyor system with a remote control device is provided, the method, performed by a control device, comprises: receiving control data from the remote control device, the control data defining user input provided through a user interface of the remote control device at least in accordance with time; comparing the control data to a reference data; and setting, in accordance with a comparison between the control data and the reference data, a detection result to express one of the following: (i) a continuation of the operation of the conveyor system, (ii) a discontinuation of the operation of the conveyor system.

At least a frequency of the user input may be defined with the reference data.

The control data may further define a position of the user input on the user interface of the remote control device in accordance with the time. A legitimate position of the user input in accordance with time may be defined with the reference data. For example, the legitimate position of the user input may be defined with a predefined pattern providable in time through the user interface of the remote control device.

Moreover, the operation of the conveyor system controlled with the activity of the user may correspond to one of the following: a movement of an elevator car, a movement of a staircase of an escalator, a movement of a conveyor belt of a moving walkway.

The method may further comprise: generating, in response to a setting of the detection result to express that the operation of the elevator conveyor system is discontinued, a control signal to cause a stopping of the conveyor system.

According to a second aspect, a control device for monitoring an activity of a user controlling an operation of a conveyor system with a remote control device is provided, the control device configured to: receive control data from a remote control device, the control data defining user input provided through a user interface of the remote control device at least in accordance with time; compare the control data to a reference data; and set, in accordance with a comparison between the control data and the reference data, a detection result to express one of the following: (i) a continuation of the operation of the conveyor system, (ii) a discontinuation of the operation of the conveyor system.

The control device may be arranged to use the reference data defining at least a frequency of the user input.

The control device may also be arranged to receive the control data further defining a position of the user input on the user interface of the remote control device in accordance with the time. The control device may be arranged to use the reference data defining a legitimate position of the user input in accordance with time. Further, the control device may be arranged to define the legitimate position of the user input with a predefined pattern providable in time.

Moreover, the control device may be arranged to, as the operation of the conveyor system controlled with the activity of the user, control one of the following: a movement of an elevator car, a movement of a staircase of an escalator, a movement of a conveyor belt of a moving walkway.

The control device may further be configured to generate, in response to a setting of the detection result to express that the operation of the conveyor system is discontinued, a control signal to cause a stopping of the conveyor system.

According to a third aspect, a system is provided, the system comprising: a remote control device, and a control device according to the second aspect as defined above.

According to a fourth aspect, a computer program product for monitoring an activity of a user controlling an operation of a conveyor system with a remote control device is provided which computer program product, when executed by at least one processor, cause a control device to perform the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically a remote control device according to an example.

FIG. 3 illustrates schematically a method according to an example.

FIGS. 4A and 4B illustrate schematically examples of control data.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

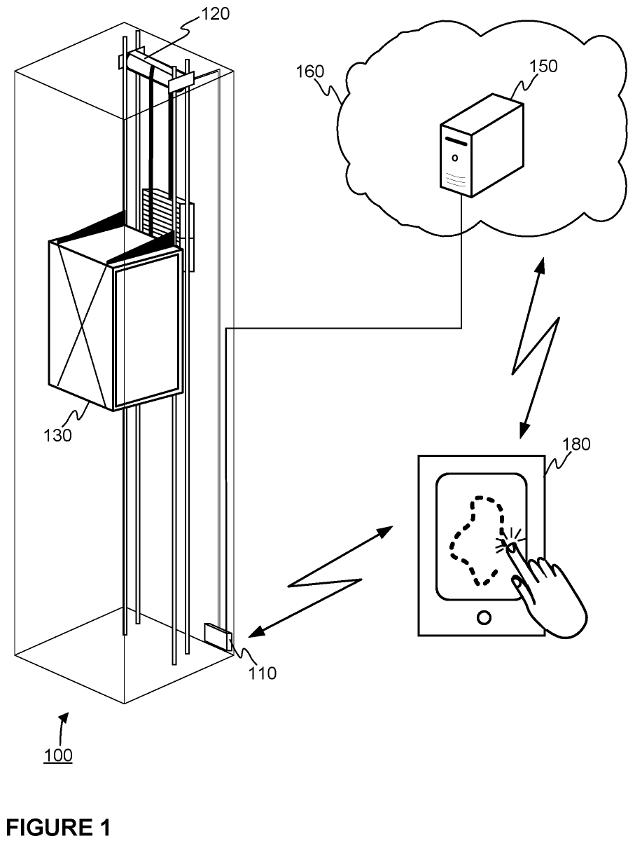

FIG. 1 illustrates schematically at least some entities for describing at least some aspects of the present invention. A system may comprise a conveyor system 100 as a sub-system, wherein the conveyor system 100 may correspond to an elevator system, an escalator, or a moving walkway, for example. The conveyor system may comprise at least one control device 110 which may e.g. correspond to a conveyor controller or a safety controller. The control device 110 may e.g. be configured to generate control signals to power generation entity 120, such as electrical drive, in order to control a movement of a conveyor 130, such as an elevator car, a staircase, or a conveyor belt, in its path. The control device 110 may be communicatively connected to a server device 150 residing in a communication network 160, such as in a data network like Internet. The server device 150 may be implemented as a standalone device or its functionality may be implemented with a plurality of server devices as a distributed computing environment. The server device 150 may be arranged to perform remote operations, such as monitoring and controlling of the conveyor system 100 in question. Furthermore, in accordance with some examples, a remote control device 180 may be communicatively connected to the control device 110 of the conveyor system 100. Alternatively or in addition, it may be communicatively connected to the server device 150 with wireless or wired connection, such as over a mobile communication network. By communicating with the server device 150 the remote control device 180 may communicate with the control device 110 in accordance with an example. In case, the remote control device 180 is arranged to be directly communicatively connected to the control device 110 the communication channel may be established in a wireless manner or with a wired connection. For wireless communication a short-range wireless communication, such as Bluetooth connection, may be applied to or alternatively the communication may be performed with wide area communication, such as over a mobile communication network. If the remote control device 180 is communicatively connected to the control device 110 with a wired connection, a communication connection based on a USB (Universal Serial Bus) technology may be applied to as a non-limiting example of the wired connection.

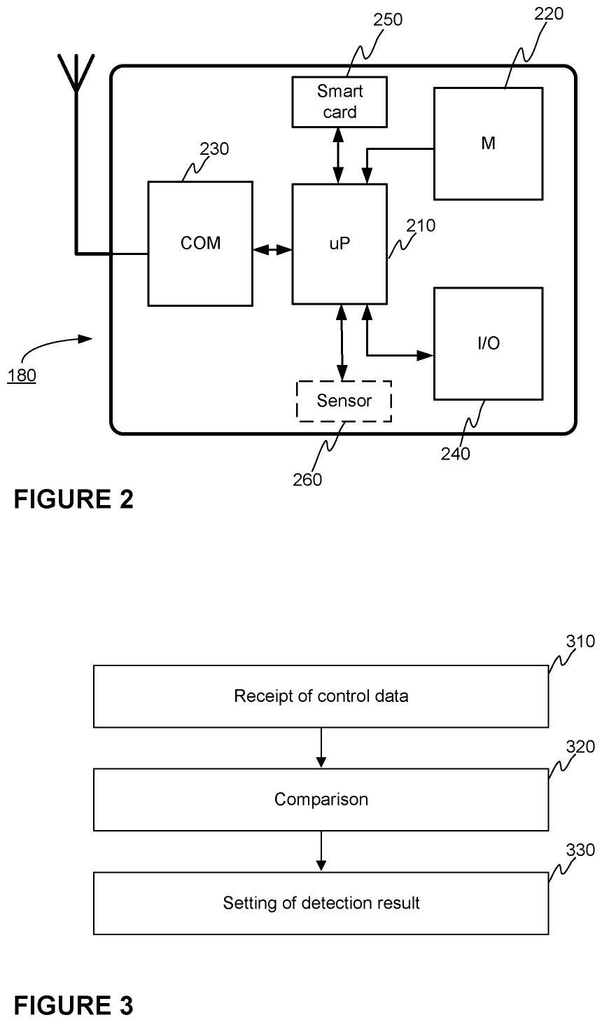

In accordance with at least some examples of the invention the remote control device 180 may refer to a terminal device the user, such as a technician, carries with him or her when the conveyor system requires maintenance work, or similar. The remote control device 180 may be used for controlling an operation of the conveyor system 100 at least to an extent as is described in the forthcoming description. FIG. 2 illustrates schematically, as a block diagram, a non-limiting example of the remote control device 180 suitable of implementing a method according to example embodiments as described in the forthcoming description. The remote control device 180 may comprise at least one processor 210 arranged to control an operation of the remote control device 180 by executing one or more computer programs. The remote control device 180 may also comprise at least one memory 220, at least one communication interface 230 and one or more input/output devices 240 for inputting and outputting information. The memory 220 may be arranged to store computer program code, but also further data, such as parameter data and any other data e.g. obtained and generated by the remote control device 180. The input/output devices may e.g. be keyboard, buttons, a touch screen, display, loudspeaker, microphone camera and so on. In some implementation of the remote control device 180 at least some of the input/output devices may be external to the remote control device 180 and coupled to it either wirelessly or in a wired manner. Further, the remote control device 180 may comprise a smart card 250 which may be needed e.g. in accessing to a mobile communication network. For example, the smart card may operate as a subscriber identity module (SIM) for the mobile communication network. The smart card 250 may be replaced with, or complemented with, one or more computer programs which may be arranged to implement a functionality of the subscriber identity module. Still further, the remote control device 180 may comprise one or more sensors for obtaining measurement data e.g. to be conveyed when the remote control device 180 is provisioned in full.

The communication interface 230 of the remote control device 180 refers to hardware and software implementation by means of which the remote control device 180 may be arranged, e.g. under control of the processor 210, to communicate with one or more communication techniques and protocols with other entities. Hence, the remote control device 180 may be arranged to be capable of communicating at least with one or more network nodes, such as with a base station, residing in the mobile communication network, but also with the control device 110 over a short-range wireless communication, or even in a wired manner.

For sake of describing further aspects in relation to the present invention it may hereby be assumed that the remote control device 180 is communicatively connected to the control device 110 for example directly with a short-range wireless communication channel, like with Bluetooth. Moreover, an application installed in the remote control device 180 may be activated either by the user of the device 180 or by triggering it from the control device 110, or any combination of these, for example. According to an example, the control device 110 may send data to the remote control device 180 to be used by the application in a monitoring of a user activity in a manner as is described in the forthcoming description. Alternatively to the implementation in which the control device 110 sends the data it may be stored e.g. together with the application in the remote control device 180 for applying it for the monitoring when the application is activated.

Further, the present solution in accordance with an example is dedicated to being applied to controlling of an operation of the conveyor system 100. In other words, the conveyor system 100 may be instructed to operate in a predefined manner. The instruction may, for example, cause the respective conveyor system 100 to move e.g. for the maintenance work. For example, an elevator car may be caused to travel in its path, or the escalator may start operating. The operation may be triggered in a predefined manner, such as through the remote control device 180 or with any other input devices, such as applicable buttons residing e.g. in the conveyor system. In the latter case, it may be arranged that the control unit 110 of the conveyor system 100 is configured to generate a signal to the remote control device 180 to indicate that the conveyor system 100 is operating in the predefined manner, such as generating a signal comprising information indicating an activation of the button, or similar. The triggering of the operation of the conveyor system 100 may cause the remote control device 180 to operate so that the application operating in the remote control device 180 starts monitoring user input through a predefined user interface in order to receive control data by means of which it is possible at least to determine if the operation of the conveyor system 100 is under control of the user. This is important in a sense that the maintenance work, or similar, is at least in part performed with the remote control device 180 and the user, such as the technician, is not necessarily in such a distance from a user interface, such as the buttons, of the conveyor system 100 e.g. to provide immediate control actions to the conveyor system 100 through the button or similar if necessary. Hence, there is need to guarantee that the user may control the operation, such as the movement, of the conveyor system 100 through the remote control device 180.

The monitoring in accordance with at least some example embodiments may be performed with a method as schematically illustrated in FIG. 3. The method is described from a viewpoint of a control device 110 arranged to receive 310 control data representing user input provided through a user interface 240 of the remote control device 180. In other words, the user of the remote control device 180 may provide, e.g. upon a request, user input on which the control data is composed for the control device 110. In accordance with some example embodiments the user input shall be provided in accordance with a predefined rule, which may define a way of the input against at least one parameter, such as with respect to a time. For example, the user may be expected to provide a number of discrete user inputs, such as pushing of a button, at predefined intervals, such as once in a second, or anything similar. Alternatively or in addition, the user may be expected to provide a predefined gesture, or pattern, with respect to time e.g. in a continuous manner with the user interface, such as through a touch screen of the remote control device 180, and information on the provision of the user input is delivered, as the control data, to the control device 110. In some example embodiments the remote control device 180, and the application executing the monitoring of the user activity, may be configured so that it prompts the user to provide the user input e.g. by outputting an applicable signal for the provision of the user input. For example, the applicable signal may be output as an audible signal, like providing a sound, such as a beep, when the user is expected to give his/her input. Alternatively or in addition, a gesture, or pattern, is visualized to the user and requested him/her to follow the visualization with his/her finger, or with other input device. The provision of the input data may be expressed at least in accordance with time, which refers to an implementation in which the user input is tied to time in some manner. For example, a time stamp may be associated to each separate user input, or time difference between consecutive user inputs is associated to the control data. In the example, in which the user provides the user input through the touch screen a total time of the provision of the user input may be associated to the control data. Furthermore, in some examples, in addition to the time information, data expressing a position of the user input may be included in the control data. For example, in case of the user input is provided through the touch screen, the user input may be expressed as coordinates with respect to a time so as to provide information to the control device 110 on the gesture, or pattern, provided with the touch screen. The touch screen may also be used for providing the user input by tapping the touch screen at intervals which is monitored in a manner as is described in the forthcoming description.

The control data composed e.g. in the manner as described may be received by the control device 110 directly from the remote control device 180 e.g. over the short-range wireless communication channel, or through a mobile communication network, or even via another entity, such as the server device 150. As described, the control data provides the information so that at least aspects relating to the time of the provision of the number of user inputs are derivable from the control data. Addition, in accordance with the implementation further data, such as information on the position of the user input on the user interface, e.g. on the touch screen, or an identifier of an input device of the user interface, such as an identifier of a button, may be included in the control data.

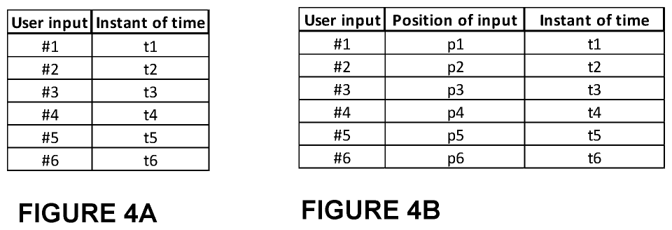

Non-limiting examples of the data carried in the control data are disclosed in FIGS. 4A and 4B. FIG. 4A may be considered to illustrate an example of the control data when the monitoring is only based on instants of time of the user input. In other words, consecutive inputs are provided by the user through the user interface, such as by pushing a predefined button consecutively, and a time stamp of the input, referred with t1, t2, t3, t4, t5, t6 in FIG. 4A, are associated, respectively, to the user inputs. FIG. 4B, in turn, illustrates an example of the control data in an implementation in which a position of the user input in accordance with time is delivered to the control device 110. In another words, the application may record user input provided e.g. through a touch screen e.g. so that a record of a position of the user input (referred with p1, p2, p3, p4, p5, p6 in FIG. 4B), if any, is made at intervals, e.g. at instants of time referred with t1, t2, t3, t4, t5, t6 in FIG. 4B and this is collected in the control data and delivered to the control device 110. This kind of implementation may be applied in a solution in which the user is prompted to follow a predefined gesture shown in the screen so as to receive information if the user is active in a proper way. The examples of the control data as shown in FIGS. 4A and 4B are non-limiting examples and any other way to monitor the user activity and to generate the control data may be used to.

In response to a receipt of the control data from the remote control device 180, wherein the control data defines, as described, user input provided through the user interface 240 of the remote control device 180 at least in accordance with time, the received control data is compared 320 to a reference data accessible to the control device 110. The reference data is defined so that it may be used for determining if the user has given the user input so that the operation of the conveyor system 100 may be continued or not. In accordance with an example, the control data may define instants of time, e.g. with applied ranges thereto, in which the user input shall be received (cf. control data of FIG. 4A). In other words, the frequency of the user input is compared to a reference frequency. Furthermore, in some other embodiments the reference data may define a position of the user input with respect to time e.g. with allowable ranges (cf. control data of FIG. 4B) so as to determine if the user has given the user input so that the operation of the conveyor system 100 may be continued or not. The comparison 320 may, hence, be made to respective reference data values to the control data. The reference data value or values may define a dedicated reference value for each input, or acceptable differences between consecutive user inputs, for example.

Finally, in accordance with the comparison 320 between the control data and the reference data the control device 110 may be arranged to set 330 a detection result to express one of the following: (i) the operation of the conveyor system 100 is continued, (ii) the operation of the conveyor system 100 is discontinued.

In other words, in some arrangements the conveyor system, or any entity therein, may be either allowed to continue its movement or instructed to stop the movement e.g. by generating a corresponding control signal in accordance with the detection result. As already mentioned, the movement of at least one of the following: a movement of an elevator car, a movement of a staircase of an escalator, a movement of a conveyor belt of a moving walkway may be controlled to.

As described the present invention enables guaranteeing that the operation of the conveyor system 100 is under control of the user interacting with the conveyor system through the remote control device 180. In addition to misconduct in the provision of the user input any deterioration e.g. in a communication connection between the remote control device 180 and the control device 110 may also be detected with the method. Namely, if the delivery of the control data is delayed, or even the connection is lost, the control device 110 may detect this by detecting that there is no control data received for performing the comparison, and in response to this the outcome of the comparison is a mismatch causing setting the detection result to express a discontinuation of the operation of the conveyor system. Hence, no activity of the user is detectable with the mechanism as described.

As already mentioned in the foregoing description the control device 110 configured to perform the monitoring of the activity of the user may be any device receiving the control data, and preferably an indication that the operation of the conveyor system 100 is triggered to. Depending on the implementation that the control device 110 may belong to a conveyor system 100, or be configured to communicate with a controller of the conveyor system, as well as with the remote control device, so as to receive the control data, but also to generate one or more control signals in accordance with the detection result.

Some aspects of the invention relate to a system comprising a remote control device 180 and a control device 110. The system, by arranging a communication connection between the mentioned entities, may allow the control device 110 to perform the method, wherein the remote control device 180 is arranged to interact with the conveyor system 100 in the manner as described.

The specific examples provided in the description given above should not be construed as limiting the applicability and/or the interpretation of the appended claims. Lists and groups of examples provided in the description given above are not exhaustive unless otherwise explicitly stated.

1. A method for monitoring an activity of a user controlling an operation of a conveyor system with a remote control device, the method, performed by a control device, comprises:
receiving control data from the remote control device, the control data defining user input provided through a user interface of the remote control device at least in accordance with time,
comparing the control data to a reference data, and
setting, in accordance with a comparison between the control data and the reference data, a detection result to express one of the following: (i) a continuation of the operation of the conveyor system, (ii) a discontinuation of the operation of the conveyor system.

2. The method of claim 1, wherein at least a frequency of the user input is defined with the reference data.

3. The method of claim 1, wherein the control data further defining a position of the user input on the user interface of the remote control device in accordance with the time.

4. The method of claim 3, wherein a legitimate position of the user input in accordance with time is defined with the reference data.

5. The method of claim 3, wherein the legitimate position of the user input is defined with a predefined pattern providable in time.

6. The method of claim 1, wherein the operation of the conveyor system controlled with the activity of the user corresponds to one of the following: a movement of an elevator car, a movement of a staircase of an escalator, a movement of a conveyor belt of a moving walkaway.

7. The method of claim 1, the method further comprising:
generating, in response to a setting of the detection result to express that the operation of the conveyor system is discontinued, a control signal to cause a stopping of the conveyor system.

8. A control device for monitoring an activity of a user controlling an operation of a conveyor system with a remote control device, the control device configured to:
receive control data from a remote control device, the control data defining user input provided through a user interface of the remote control device at least in accordance with time, compare the control data to a reference data, and
set, in accordance with a comparison between the control data and the reference data, a detection result to express one of the following: (i) a continuation of the operation of the conveyor system, (ii) a discontinuation of the operation of the conveyor system.

9. The control device of claim 8, wherein the control device is arranged to use the reference data defining at least a frequency of the user input.

10. The control device of claim 8, wherein the control device is arranged to receive the control data further defining a position of the user input on the user interface of the remote control device in accordance with the time.

11. The control device of claim 10, wherein the control device is arranged to use the reference data defining a legitimate position of the user input in accordance with time.

12. The control device of claim 10, wherein the control device is arranged to define the legitimate position of the user input with a predefined pattern providable in time.

13. The control device of claim 8, wherein the control device is arranged to, as the operation of the conveyor system controlled with the activity of the user, control one of the following: a movement of an elevator car, a movement of a staircase of an escalator, a movement of a conveyor belt of a moving walkway.

14. The control device of claim 8, the control device is further configured to generate, in response to a setting of the detection result to express that the operation of the conveyor system is discontinued, a control signal to cause a stopping of the conveyor system.

15. A system, comprising:
a remote control device, and
a control device according to claim 8.

16. A non-transitory computer readable medium storing a computer program for monitoring an activity of a user controlling an operation of a conveyor system with a remote control device which, when executed by at least one processor, cause a control device to perform the method according to claim 1.

17. The method of claim 4, wherein the legitimate position of the user input is defined with a predefined pattern providable in time.

18. The method of claim 2, wherein the operation of the conveyor system controlled with the activity of the user corresponds to one of the following: a movement of an elevator car, a movement of a staircase of an escalator, a movement of a conveyor belt of a moving walkaway.

19. The method of claim 3, wherein the operation of the conveyor system controlled with the activity of the user corresponds to one of the following: a movement of an elevator car, a movement of a staircase of an escalator, a movement of a conveyor belt of a moving walkaway.

20. The method of claim 4, wherein the operation of the conveyor system controlled with the activity of the user corresponds to one of the following: a movement of an elevator car, a movement of a staircase of an escalator, a movement of a conveyor belt of a moving walkaway.
